(19) United States
(12) Patent Application Publication
(10) Pub. No.: US 2013/0325619 A1
(43) Pub. Date: Dec. 5, 2013

(54) SAVING ELECTRONIC COUPONS FOR FUTURE USE

(71) Applicant: Shane Thomas Lile, Redmond, WA (US)

(72) Inventor: Shane Thomas Lile, Redmond, WA (US)

(73) Assignee: Microsoft Corporation, Redmond, WA (US)

(21) Appl. No.: 13/489,127

(22) Filed: Jun. 5, 2012

(51) Int. Cl. G06Q 30/02

(52) U.S. Cl. 705/14.64; 705/14.73

(57) ABSTRACT

An advertising platform can embed metadata into a coupon such that the coupon can be saved together with other coupons for later use. The coupons can be associated with multiple different, and unrelated stores. Additionally, the coupons can be stored together in a common coupon storage area, located locally or on a network. The coupons can have two separate selectable portions. A first portion can allow the user to download a webpage associated with the coupon to view additional information associated with the product or service offered for sale. A second portion can allow the user to save the coupon for later use.

### FIELD

The present application relates to electronic coupons, and, more particularly, saving electronic coupons for future use.

### BACKGROUND

Selling goods and services through websites on the Internet has become commonplace. Merchants operating websites that offer goods and services for sale often place advertisements on other websites (web portals) in order to inform potential customers about their offerings, and to direct users to web pages where purchases can be made.

A typical example is where a user is reading a news story or other content and an advertisement is displayed on the same webpage as the story. Sometimes the advertisements change, such that if the user failed to select the advertisement after a predetermined period of time, the advertisement rotates to a next advertisement in a queue, as there is an increased probability that the user is not interested in an unselected advertisement. Thus, there is some pressure on the user to select the advertisement within a limited period of time or otherwise lose the opportunity to do so. The advertisements typically have an associated Internet address or hyperlink and if the advertisement is selected, the currently displayed content is replaced with a different webpage downloaded from the Internet address. Thus, the news story that the user was reading was displaced and interrupted. As a result, the overall user experience reading web content containing advertisements can be disruptive and not relaxing.

### SUMMARY

The present application allows a coupon to be displayed and saved in a manner that it is usable at a later time. Coupons are typically displayed as pop-up windows or as a banner ad, and an option is provided to save the coupon.

In one embodiment, an advertising platform can embed metadata into a coupon such that the coupon can be saved together with other coupons for later use. The coupons can be associated with multiple different, and unrelated stores (e.g., Starbucks®, Macy's®, etc.). Additionally, the coupons can be stored together in a common coupon storage area, located locally or on a network.

In another embodiment, the coupons can have two separate selectable portions. A first portion can allow the user to download a webpage associated with the coupon to view additional information associated with the product or service offered for sale. A second portion can allow the user to save the coupon for later use without downloading the associated web page.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary display showing a coupon being saved to a coupon storage.

FIG. 2 is an embodiment of a system wherein an advertising engine displays the coupon through an advertisement control that can store the coupon in a local coupon storage.

FIG. 3 is an alternative embodiment of a system wherein the coupon storage is located on a network.

FIG. 4 is an embodiment of a system wherein a save option in an advertisement interacts through an API to save a coupon in a coupon storage.

FIG. 5 is an exemplary mobile device including a coupon storage.

FIG. 6 shows the coupon storage can be located in the cloud, and accessible to multiple different platforms.

FIG. 7 is a flowchart of a method for implementing a coupon storage.

FIG. 8 is a flowchart showing additional process blocks that can be implemented in conjunction with FIG. 7.

### DETAILED DESCRIPTION

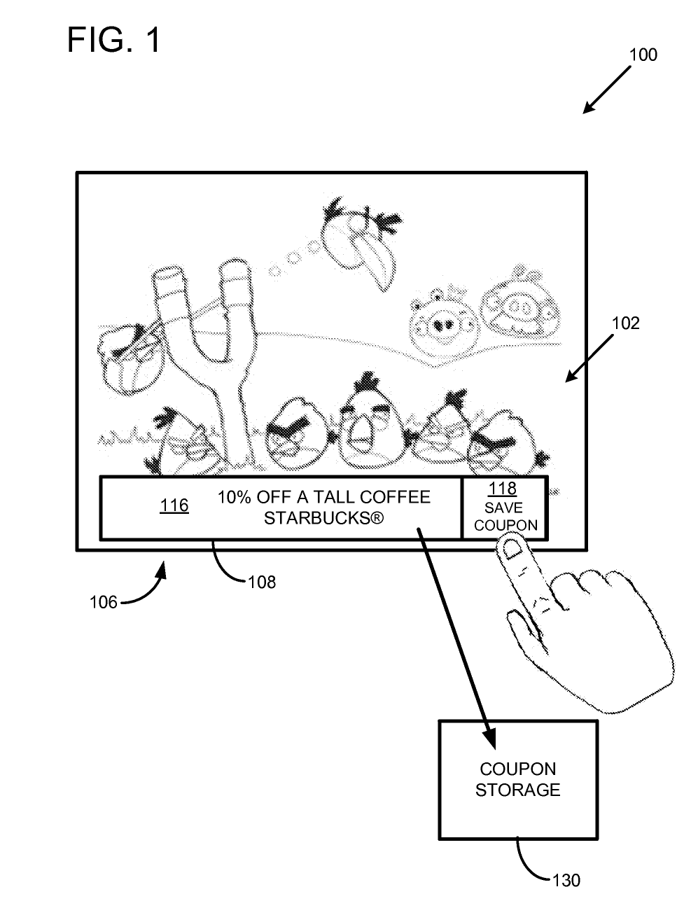

FIG. 1 shows an embodiment of a display system 100 on a client device, wherein content is generally shown at 102 and is the primary content being displayed to a user. In this case, the content 102 is a game, but other content can be displayed, such as news, sports, or any other textual, visual or auditory information. The content 102 generally is received from a first source, such as a first server computer or can be sourced locally from the client device itself. An advertisement 106 can be displayed as a pop-up window 108. The advertisement can also be in the form of a banner ad or any other display format. In any event, the advertisement is generally visualized as overlapping the primary content 102, or at least consuming some of the client display area. In the particular example shown in FIG. 1, the advertisement is a coupon for a coffee. The illustrated coupon includes two portions, 116 and 118. The portion 116 can include the primary text associated with the coupon together with metadata (e.g., web address) used for downloading additional information about the coupon. The second portion 118 can include metadata for storing the coupon in a coupon storage 130. The metadata associated with the second portion can include one or more of the following: an expiration date, a description of the coupon (e.g., merchant, terms, etc.), an identifier (e.g., UPC), etc. Thus, each portion of the advertisement can be separately selected for performing different actions. As further described below, the coupon storage can be a storage area where multiple coupons from other retail stores are located. For example, the coupon associated with Starbucks® can be stored with coupons from multiple other stores (McDonalds®, REI®, etc.) not associated with Starbucks®. Thus, multiple merchant coupons can be stored in a single database, for example. One advantage of the implementation shown in FIG. 1 is that a coupon can be stored for later use without interrupting the experience provided by the currently displayed content. For example, the user need not interrupt the game being played (at content 102), because the coupon 116 can be viewed, redeemed and consumed at a later time. Thus, in the instant example, a user can save the coupon, continue playing the game without interruption, and can later retrieve the coupon from storage for use.

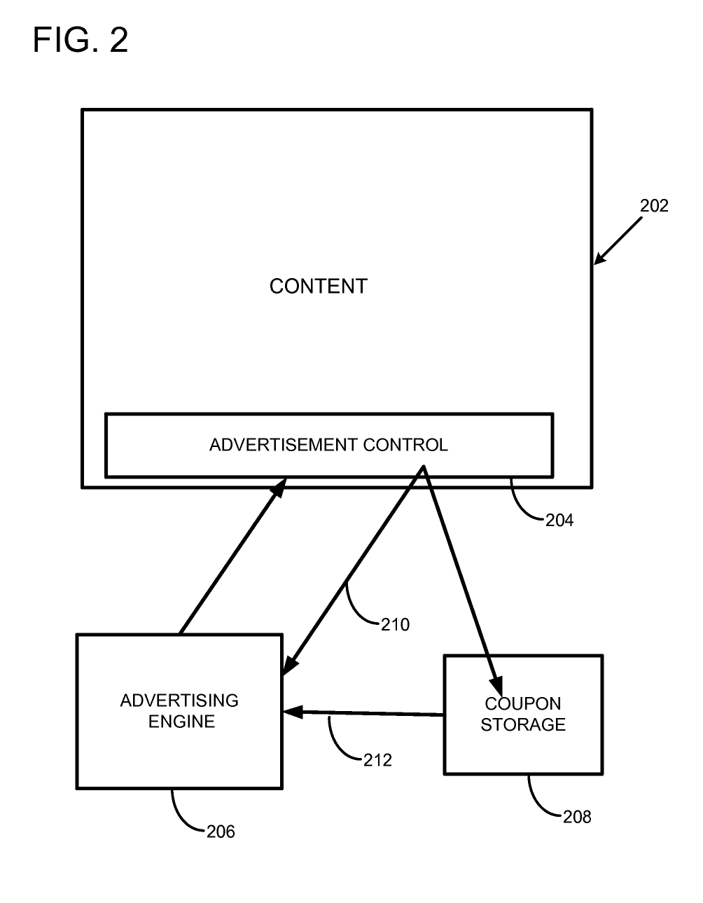

FIG. 2 is an exemplary system wherein content 202 is being displayed. The content is the primary content being viewed by a user on a client device, but the displayed content can include an embedded advertisement control 204. The control allows differently sourced content to be embedded within the content 202 (i.e., the control's content and content 202 can be sourced from different computers). An advertising engine 206 can be used to transmit an advertisement (e.g., coupon) to be displayed in the space delineated by the advertisement control. Under user control, the currently displayed advertisement can be stored in the coupon storage 208. Additionally, the advertisement control 204 can send data back to the advertising engine (as shown by arrow 210) for measuring ad impression, which includes monitoring a number of users that act upon the advertisement through selection. Additionally, the advertisement engine can retrieve information from the coupon storage 208 (as shown by arrow 212) in order to determine coupons that are already stored. Using this information, the advertisement engine can make intelligent decisions about what next coupons to advertisement. In a simple example, coupons already stored need not be displayed again. This allows an increased efficiency in advertising on the client display. If the coupon is selected for saving, the coupon can be removed from the display allowing the content to consume additional display area previously consumed by the advertisement control 204. As such, the content can be reformatted to fill-up the display area.

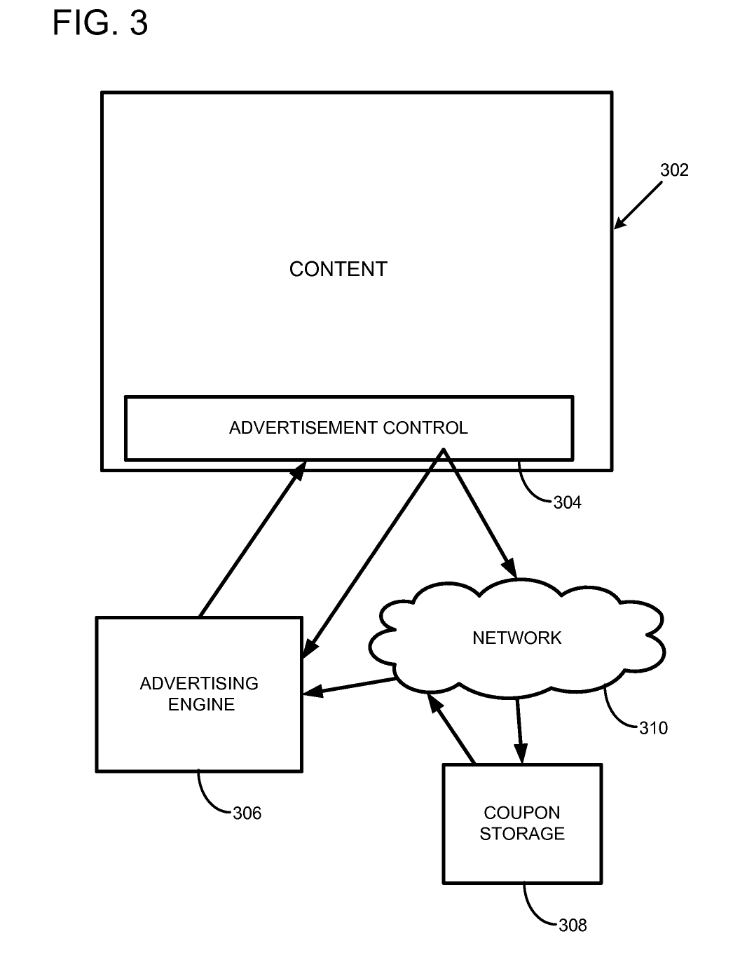

FIG. 3 is another embodiment of an exemplary system. In this case, content 302 is displayed and includes an embedded advertisement control 304, which receives content to be displayed from an advertising engine 306. If selected for storage, the advertisement control stores the selected coupon to a coupon storage 308 using a network 310. The coupon storage can also communicate with the advertising engine 306 through the network 310. Thus, the coupon storage can be located in the cloud and accessible to other client devices, as further described below. As with other embodiments, storage of the coupon can include data, such as identification of a merchant, expiration date and a coupon identifier, such as a UPC. The coupon data can be transmitted to the server together with an identifier of the user (e.g., GUID).

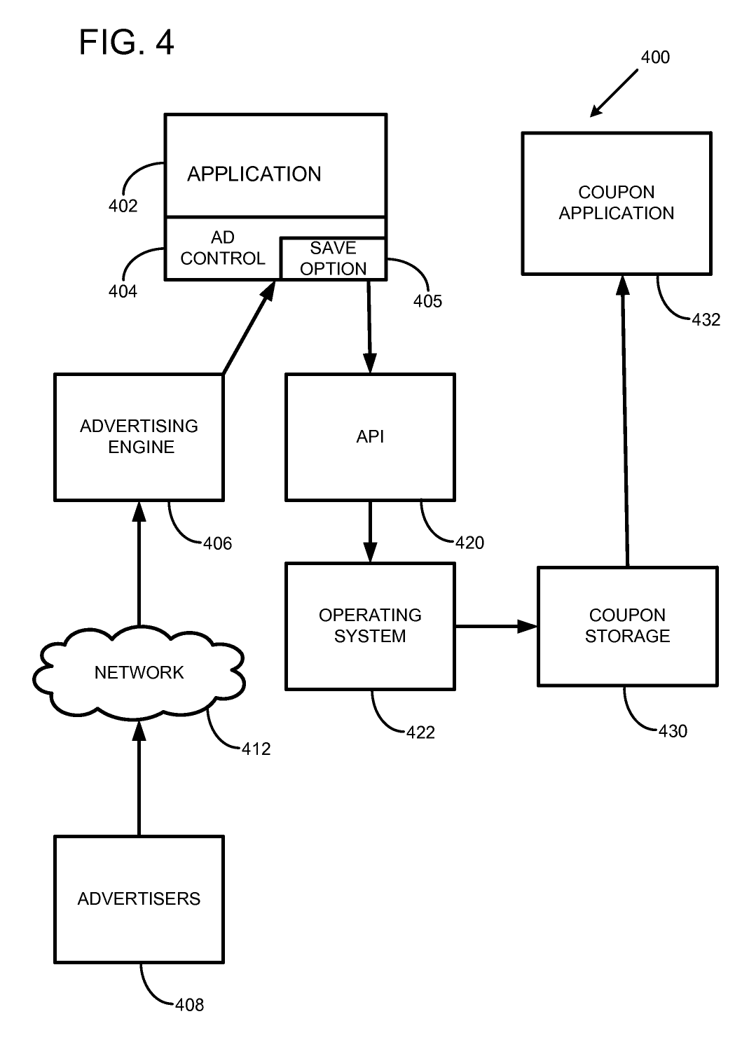

FIG. 4 shows an exemplary client system 400 in which an application 402 can execute and display content. An ad control 404 can be embedded in the content for displaying advertisements unrelated to the displayed content. By related content, it is meant that the content displayed by application 402 is a store and the ad is simply a coupon at that same store. By unrelated, it is meant that the content can be virtually anything, and the coupon is related to a store or service not associated with the content. A save option button 405 can be embedded in the control and allow user input to save the coupon. An advertising engine 406 can communicate with advertisers 408 through a network 412. The advertisers 408 upload the desired ads to the advertisement engine 406, which, in turn, decides on an order in which to display the ads in the ad control 404. If the user selects the save option 405, meta data is used to communicate with an operating system 422 through an API 420. The operating system can then store the coupon in a coupon storage 430. A coupon application 432, running on the client device, can be used to access the coupon storage and retrieve coupons when needed by the user. As such, the coupon application can have search commands for searching the coupon storage 430. Thus, if a user is currently at a retail store, he/she can check their coupon storage to determine if any saved coupons are available. Thus, a user can save an advertisement in a manner that makes it usable as a coupon for physical or online purchases. In so doing, an advertisement can interact with the user's device for later consumption with the user's consent.

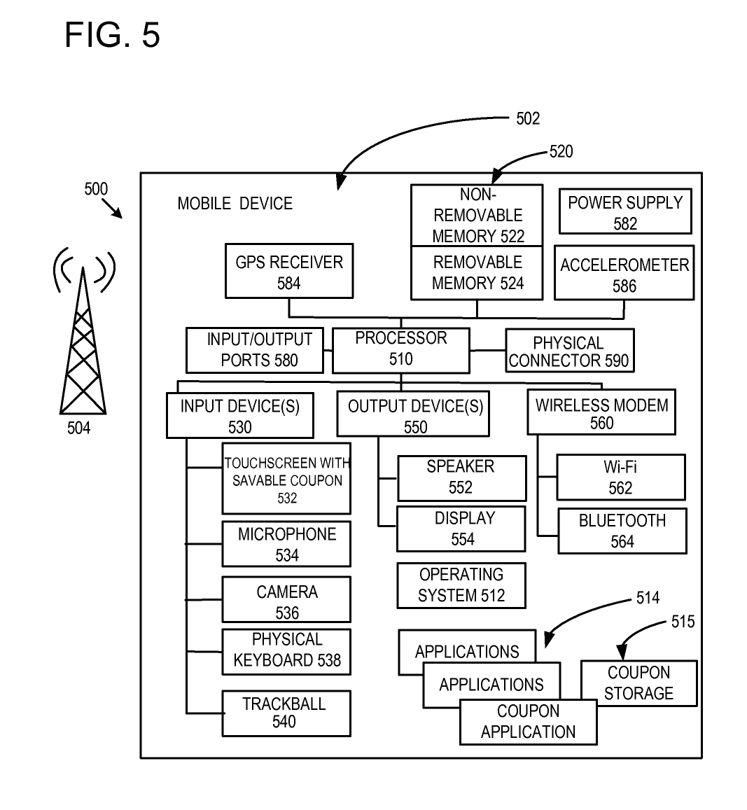

FIG. 5 is a system diagram depicting an exemplary mobile device 500 including a variety of optional hardware and software components, shown generally at 502. Any components 502 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 504, such as a cellular or satellite network.

The illustrated mobile device 500 can include a controller or processor 510 (e.g., signal processor, microprocessor, ASIC, or other control and processing logic circuitry) for performing such tasks as signal coding, data processing, input/output processing, power control, and/or other functions. An operating system 512 can control the allocation and usage of the components 502 and support for one or more application programs 514. The application programs can include common mobile computing applications (e.g., email applications, calendars, contact managers, web browsers, messaging applications), or any other computing application. A coupon retrieval application can also be provided to retrieve coupons from a coupon storage 515.

The illustrated mobile device 500 can include memory 520. Memory 520 can include non-removable memory 522 and/or removable memory 524. The non-removable memory 522 can include RAM, ROM, flash memory, a hard disk, or other well-known memory storage technologies. The removable memory 524 can include flash memory or a Subscriber Identity Module (SIM) card, which is well known in GSM communication systems, or other well-known memory storage technologies, such as “smart cards.” The memory 520 can be used for storing data and/or code for running the operating system 512 and the applications 514. Example data can include web pages, text, images, sound files, video data, or other data sets to be sent to and/or received from one or more network servers or other devices via one or more wired or wireless networks. The memory 520 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The memory can also be used for implementing the coupon storage 515.

The mobile device 500 can support one or more input devices 530, such as a touchscreen 532, microphone 534, camera 536, physical keyboard 538 and/or trackball 540 and one or more output devices 550, such as a speaker 552 and a display 554. Other possible output devices (not shown) can include piezoelectric or other haptic output devices. Some devices can serve more than one input/output function. For example, touchscreen 532 and display 554 can be combined in a single input/output device.

A wireless modem 560 can be coupled to an antenna (not shown) and can support two-way communications between the processor 510 and external devices, as is well understood in the art. The modem 560 is shown generically and can include a cellular modem for communicating with the mobile communication network 504 and/or other radio-based modems (e.g., Bluetooth or Wi-Fi). The wireless modem 560 is typically configured for communication with one or more cellular networks, such as a GSM network for data and voice communications within a single cellular network, between cellular networks, or between the mobile device and a public switched telephone network (PSTN).

The mobile device can further include at least one input/output port 580, a power supply 582, a satellite navigation system receiver 584, such as a Global Positioning System (GPS) receiver, an accelerometer 586, and/or a physical connector 590, which can be a USB port, IEEE 1394 (FireWire) port, and/or RS-232 port. The illustrated components 502 are not required or all-inclusive, as any components can deleted and other components can be added.

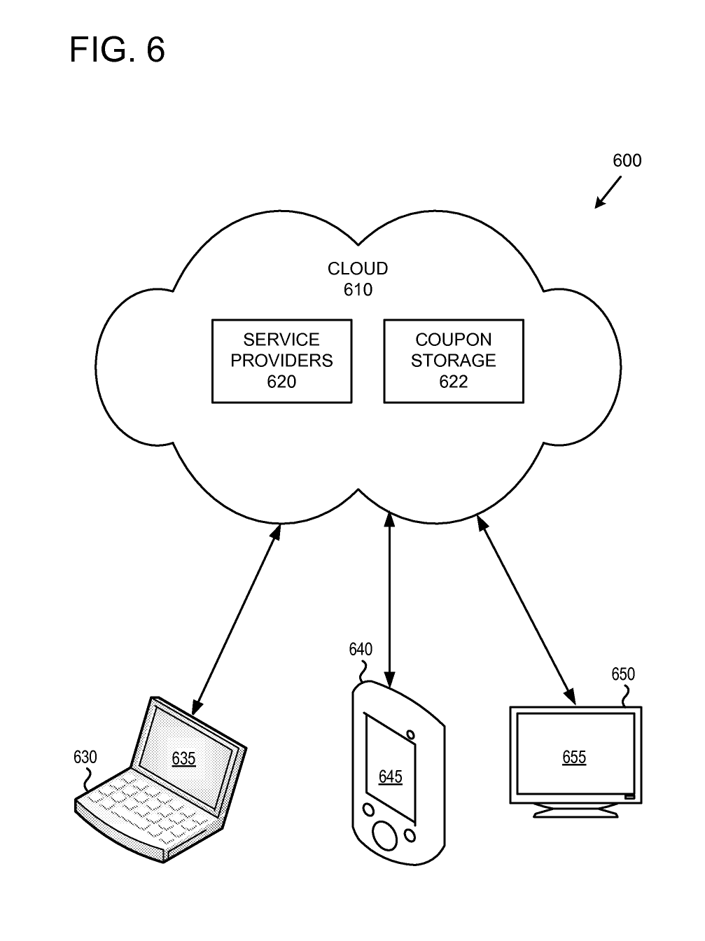

FIG. 6 illustrates a generalized example of a suitable implementation environment 600 in which described embodiments, techniques, and technologies may be implemented.

In example environment 600, various types of services (e.g., computing services) are provided by a cloud 610. For example, the cloud 610 can comprise a collection of computing devices, which may be located centrally or distributed, that provide cloud-based services to various types of users and devices connected via a network such as the Internet. The implementation environment 600 can be used in different ways to accomplish computing tasks. For example, some tasks (e.g., processing user input and presenting a user interface) can be performed on local computing devices (e.g., connected devices 630, 640, 650) while other tasks (e.g., storage of data to be used in subsequent processing) can be performed in the cloud 610.

In example environment 600, the cloud 610 provides services for connected devices 630, 640, 650 with a variety of screen capabilities. Connected device 630 represents a device with a computer screen 635 (e.g., a mid-size screen). For example, connected device 630 could be a personal computer such as desktop computer, laptop, notebook, netbook, or the like. Connected device 640 represents a device with a mobile device screen 645 (e.g., a small size screen). For example, connected device 640 could be a mobile phone, smart phone, personal digital assistant, tablet computer, or the like. Connected device 650 represents a device with a large screen 655. For example, connected device 650 could be a television screen (e.g., a smart television) or another device connected to a television (e.g., a set-top box or gaming console) or the like. One or more of the connected devices 630, 640, 650 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 600. For example, the cloud 610 can provide services for one or more computers (e.g., server computers) without displays.

Services can be provided by the cloud 610 through service providers 620, or through other providers of online services (not depicted). For example, cloud services can be customized to the screen size, display capability, and/or touchscreen capability of a particular connected device (e.g., connected devices 630, 640, 650). A coupon storage 622 can be located in the cloud and accessible to any of the connected devices. Thus, multiple client devices can share the coupon storage for making purchases. Additionally, coupon applications on the connected devices 630, 640, 650 can access the coupon storage for retrieving, using and consuming the coupons.

In example environment 600, the cloud 610 provides the technologies and solutions described herein to the various connected devices 630, 640, 650 using, at least in part, the service providers 620. For example, the service providers 620 can provide a centralized solution for various cloud-based services. The service providers 620 can manage service subscriptions for users and/or devices (e.g., for the connected devices 630, 640, 650 and/or their respective users).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

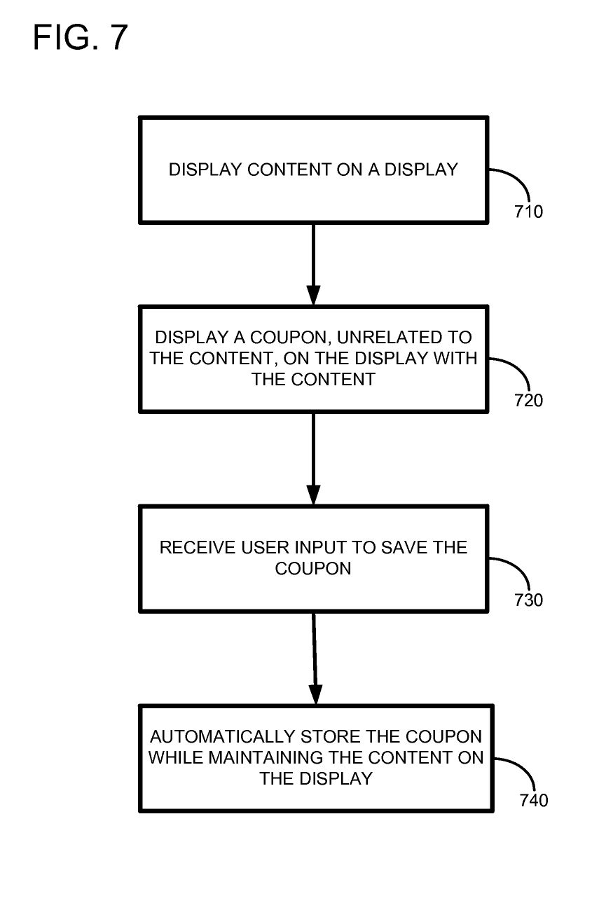

FIG. 7 is a flowchart of a method for storing coupons. In process block 710, content is displayed on a client display. The content can be a news story, game, or any web content downloaded from the Internet. Generally, the content is from a first source. In process block 720, a coupon is displayed that is unrelated to the content. Thus, the coupon relates to a product that is for sale from a retailer not associated with the content being displayed. In another example, the source of the content is not associated with the source of the coupon. In process block 730, user input is received to save the coupon. For example, the source of the content can be from a first server computer associated with a first company and the source of the coupon can be from a second server computer from a second company, not affiliated with the first company. In process block 740, the coupon is automatically stored in coupon storage while maintaining the content on the display. Thus, the content is continuously displayed while the coupon is being stored so as not to interrupt the display of the content.

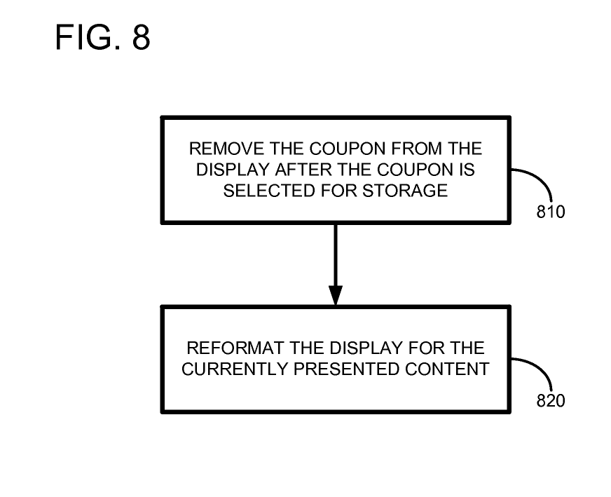

FIG. 8 is a flowchart of additional possible process blocks that can be used. In process block 810, after the coupon is selected by a user, the coupon can be removed from the display. In process block 820, with the coupon removed, the advertisement control can relinquish control to the main client display. As such, the display can reformat the currently displayed content to take advantage of the additional space.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of storing coupons on a computing device, comprising:
displaying content on a display of the computing device;
displaying a coupon, unrelated to the content, on the display at a same time as the content;
receiving user input to save the coupon; and
in response to the user input, automatically storing the coupon while continuing to maintain the content on the display.

2. The method of claim 1, further including removing the coupon from the display in response to the user input.

3. The method of claim 2, further including reformatting the displayed content in response to removal of the coupon.

4. The method of claim 1, wherein the coupon is associated with purchasing a product at a store, and wherein the displayed content is unrelated to the store.

5. The method of claim 4, wherein the content is a news story.

6. The method of claim 1, wherein storing the coupon includes storing the coupon in a coupon storage on the computing device in association with other coupons.

7. The method of claim 6, wherein the computing device is a mobile phone and the coupon storage includes memory on the mobile phone.

8. The method of claim 1, wherein the coupon includes a first selectable portion and a second selectable portion, the first selectable portion associated with an Internet address, such that if selected by a user, the content is replaced by different content downloaded from a server associated with the Internet address, and the second selectable portion associated with the automatic storing of the coupon so that the content is maintained on the display.

9. The method of claim 1, wherein the coupon is related to a product for sale at a first store, and the storing of the coupon includes storing the coupon together with other coupons from stores other than the first store.

10. The method of claim 1, wherein storing the coupon includes transmitting coupon data to a server computer together with an identifier of the user for storage of the coupon on the server computer.

11. The method of claim 1, wherein automatically storing the coupon includes storing a coupon identifier together with a merchant identifier and an expiration date of the coupon.

12. A computer-readable storage device having encoded therein computer-executable instructions for causing a computing device programmed thereby to perform a method of storing coupons, comprising:
displaying content on a display of the computing device;
displaying a coupon, related to a product for sale at a first store, on the display at a same time as the content;
receiving user input to save the coupon; and
in response to the user input, automatically storing the coupon together with coupons related to products for sale at multiple other stores not associated with the first store, while continuing to maintain the content on the display.

13. The computer-readable storage device of claim 12, wherein displaying the coupon includes displaying the coupon in a pop-up window that overlaps the content and further including removing the pop-up window from the display in response to the user input.

14. The computer-readable storage device of claim 13, further including reformatting the displayed content in response to removal of the coupon.

15. The computer-readable storage device of claim 12, further including checking whether the coupon was previously selected prior to displaying the coupon.

16. The computer-readable storage device of claim 12, wherein storing the coupon includes storing the coupon in a coupon storage on the computing device.

17. The computer-readable storage device of claim 16, wherein the computing device is a mobile phone and the coupon storage includes memory on the mobile phone.

18. The computer-readable storage device of claim 12, wherein the coupon includes a first selectable portion and a second selectable portion, the first selectable portion associated with an Internet address, such that if selected by a user, the content is replaced by different content downloaded from a server associated with the Internet address, and the second selectable portion associated with the automatic storing of the coupon so that the content is maintained on the display.

19. The computer-readable storage device of claim 12, wherein automatically storing the coupon includes storing a coupon identifier together with a merchant identifier and an expiration date of the coupon.

20. A mobile phone with coupon storage, comprising:
a processor for executing an application that displays content on a first portion of a display of the mobile phone;
an advertising engine for displaying coupons in an advertisement control that controls a second portion of the display, wherein selection of a coupon causes automatic downloading of a web page associated with the coupon; and
a save option associated with the advertisement control for saving data associated with a currently displayed coupon to a coupon storage for later use without the automatic downloading of the web page associated with the coupon.
